(19) United States
(12) Patent Application Publication
(10) Pub. No.: US 2007/0236801 A1
(43) Pub. Date: Oct. 11, 2007

(54) Time-multiplexed 3D display system with beam splitter

(75) Inventors: Soohyun Cha, Woodland Hills, CA (US); John Moore, Cambridge (GB); Dan Mapes, Los Angeles, CA (US)

Correspondence Address: BLAKELY SOKOLOFF TAYLOR & ZAFMAN, 1279 OAKMEAD PARKWAY, SUNNYVALE, CA, 94085-4040, US

(73) Assignee: Deep Light, LLC

(21) Appl. No.: 11/392,377

(22) Filed: Mar. 28, 2006

(51) Int. Cl. G02B 3/00

(52) U.S. Cl. 359/642; 348/51

(57) ABSTRACT

A time multiplexed 3D display incorporates a beam splitter so that multiple viewers can watch the same content in a plurality of different positions.

### BACKGROUND OF THE INVENTION

1. Field of the Invention

This invention relates generally to the field of video display systems. More particularly, the invention relates to an autostereoscopic system for presenting a three dimensional display in which a beam splitter provides an increased number of viewing positions.

2. Background

Time multiplexing technology for achieving a three dimensional display is described in U.S. Pat. No. 5,132,839. The system disclosed therein comprises an image projector or “backlighting” apparatus for projecting beams of light in selected directions, a spatial light modulator or shutter for displaying images back lit by the backlighting apparatus and a control system coupled to both the spatial light modulator and the backlighting apparatus. The control system causes a plurality of images of an object to be formed in succession on the spatial light modulator with each image being a view of the subject form a different angle, and each image being viewable only from particular angles. The images are formed one at a time on the spatial light modulator with a plurality of images constituting a single frame of a video picture. In the described embodiments, the backlighting apparatus includes a two dimensional display device for emitting spots of lights at selected locations along the two dimensional display, and a lens system for refracting light emitted by the two dimensional display device. The lens system refracts beams emanating from a spot of light on the two dimensional display into substantially parallel rays. The different individual views of the subject are thus projected onto an image plane at discrete horizontal positions, referred to as eye boxes or view ports, the positions being spaced apart by a distance that is less than the inter-occular spacing of a human. An observer is thus presented with a stereoscopic view of the subject. Furthermore, a sufficient number of different views are provided so that the observer may move from side to side to “see” the subject from different angles.

The number of different view angles in such an autostereoscopic display system is limited by practical considerations, including the image refresh rate of the image projector and the size of the shutter. Thus, the horizontal field of view is necessarily limited.

There have been a few efforts to increase the field of view, such as tiling multiple time-multiplexed 3D displays side by side. Those efforts have indeed increased the field of view, but have also increased the material cost severely or were otherwise not commercially viable. U.S. Pat. No. 6,224,214 assigned to Litton Systems, Inc. proposes using multiple projectors side by side. Each projector displays a certain number of views. The total number of views available in the system is the product of the number of views displayed by each projector and the number of projectors. Litton demonstrated such a multiple projector system having a total of 28 views (28 different view points) using 4 projectors, each displaying 7 views. However, the cost was four times that of a single projector. Furthermore, the system produced noticeable seam lines between the projectors, even though efforts were made to minimize this effect.

Dr. Adrian Travis, the inventor of the time multiplexed 3D display technology, has also invented a method of widening the field of view using an onion shaped lens and multiple micro displays. This approach seems simpler than Litton's approach, but a practical implementation has not yet been developed.

### SUMMARY OF THE INVENTION

The present invention utilizes a beam splitter to increase the number of viewing positions in a time multiplexed 3D display so that multiple viewers can watch the same content in a plurality of different positions. The additional viewing positions can thus be provided in a system using a single image projector.

### BRIEF DESCRIPTION OF THE DRAWINGS

FIG. 1 is a schematic diagram of a prior art auto-stereoscopic display system.

FIG. 2 is a schematic diagram of a 3D display system in accordance with one embodiment of the present invention.

### DETAILED DESCRIPTION OF THE INVENTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

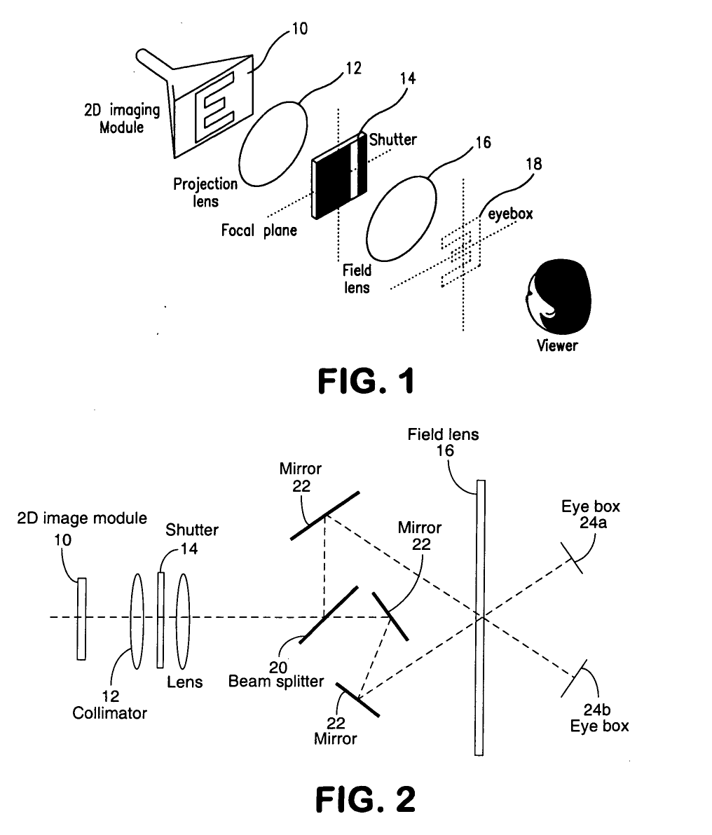

FIG. 1 is a schematic diagram of a prior art display system producing an auto-stereoscopic 3D display. Such a system is more fully described in U.S. Pat. No. 5,132,829, the disclosure of which is incorporated herein by reference. The system comprises an imaging module 10, such as a cathode ray tube (CRT) or other light projecting imaging device. Another suitable imaging module comprises a high intensity light source directed onto a silicon wafer having a large plurality of steerable micro-mirrors. Such an image-generating device is referred to as a digital light processor (DLP). The image generated by module 10 is focused by projection lens 12 onto a focal plane in which a spatial light modulator or shutter 14 is placed. Imaging module 10 generates a plurality of images of a subject in succession, each image being a view of the subject from a different angle. Spatial light modulator 14 is synchronized with the succession of images so that each image is viewable only from a corresponding viewing angle. The images are focused by field lens 16 at a respective eye box or view port 18. Field lens 16 may comprise a Fresnel lens, a curved mirror or other suitable optical focusing device.

Using a single image projector in a time multiplexed 3D display, a certain number of views can be displayed, giving both auto-stereoscopic and look around capabilities for a realistic three dimensional viewing experience. For example, with the latest DLP technology, 10-20 views are possible, occupying about 1° for each view. This effectively limits the system to use by a single individual. In the present invention, a beam splitter is introduced in the relay section of the time multiplexed 3D display device to create multiple photon streams of identical views. The field lens (Fresnel lens or curved mirror) may be shared by the different photon streams.

FIG. 2 is a schematic diagram of a 3D display system in accordance with one embodiment of the present invention. A beam splitter 20 divides the optical output from shutter 14 into two identical photon streams. These are reflected by mirrors 22 to eye boxes 24a and 24b. Thus, two viewing positions are available, each having a full complement of projected images. Since most of the optical components are shared, this provides a cost effective way to provide plural viewing positions. As illustrated, the beam splitter is introduced in the relay section of the 3D display system to create two identical photon streams, and thus two viewing positions with identical view ports. Additional beam splitters can be introduced to create additional viewing positions. However, considering the reduction of beam strength after the beam splitter, two or three beam splitters are a practical limitation.

As shown in the particular embodiment illustrated in FIG. 2, beam splitter 20 is a half-silvered mirror. This is a plate of glass with a thin coating of silver (usually deposited from silver vapor) with the thickness of the silver coating such that, for light incident at a 45 degree angle, one half is transmitted and one half is reflected. Instead of a silver coating, a dielectric optical coating may be used. The ratio of reflection to transmission can be controlled.

Other devices may be used for beam splitter 20 in lieu of a half-silvered mirror. For example, the beam splitter may comprise a cube made from two triangular glass prisms that are glued together at their base using an optically neutral adhesive, such as Canada balsam. As another example, the beam splitter may comprise a dichroic mirrored prism assembly that splits the incoming light into three beams, one each of red, green and blue. Such a device has been used in multi-tube color television cameras and also in 3-film Technicolor movie cameras.

It will be recognized that the above-described invention may be embodied in other specific forms without departing from the spirit or essential characteristics of the disclosure. Thus, it is understood that the invention is not to be limited by the foregoing illustrative details, but rather is to be defined by the appended claims.

What is claimed is:

1. A 3D display system comprising:
an image source;
a shutter optically coupled to the image source;
a controller coupled to and controlling the image source and coupled to and controlling the shutter for causing each of a succession of images from the image source to be directed in a different direction;
a beam splitter dividing an image directed from the shutter into a plurality of image beams;
means for focusing the plurality of image beams into a corresponding plurality of view ports.

2. The 3D display system of claim 1 wherein the beam splitter comprises a plurality of prisms.

3. The 3D display system of claim 1 wherein the beam splitter comprises a semi-reflective, semi-transparent mirror.

4. The 3D display system of claim 1 wherein the beam splitter comprises a dichroic prism.

5. The 3D display system of claim 1 wherein the means for focusing comprises a Fresnel lens.

6. The 3D display system of claim 1 wherein the means for focusing comprises a curved mirror.
